(19) United States
(12) Patent Application Publication
(10) Pub. No.: US 2019/0366433 A1
(43) Pub. Date: Dec. 5, 2019

(54) Producing Workpieces With an Additive Production Method

(71) Applicant: Siemens Aktiengesellschaft, München (DE)

(72) Inventors: Ömer Aydin, Berlin (DE); Heinz Pilz, Teltow (DE)

(73) Assignee: Siemens Aktiengesellschaft, München (DE)

(21) Appl. No.: 16/334,096

(22) PCT Filed: Sep. 13, 2017
(86) PCT No.: PCT/EP2017/072955

§ 371 Date: Mar. 18, 2019

(30) Foreign Application Priority Data
Sep. 22, 2016 (DE) 10 2016 218 249.8

(51) Int. Cl. B22F 3/105; B29C 64/153; B29C 64/214

(52) U.S. Cl. CPC B22F 3/1055; B33Y 10/00; B29C 64/214; B29C 64/153

(57) ABSTRACT

Various embodiments include a method for producing a workpiece by means of an additive production method comprising: producing a powder bed slice by slice; smoothing a respective slice being produced with an edge of a slide down to a target level of the respective slice; raising the edge of the slide if an obstacle projects from the target level in the powder bed to a deflection level above the obstacle and, after it has passed the obstacle, lowering the edge of the slide back down to the target level; after the slide has passed the obstacle, smoothing the powder bed in an area of the obstacle using a brush; and building a workpiece slice by slice using local hardening of the powder.

### CROSS-REFERENCE TO RELATED APPLICATIONS

This application is a U.S. National Stage Application of International Application No. PCT/EP2017/072955 filed Sep. 13, 2017, which designates the United States of America, and claims priority to DE Application No. 10 2016 218 249.8 filed Sep. 22, 2016, the contents of which are hereby incorporated by reference in their entirety.

### TECHNICAL FIELD

The present disclosure relates to additive manufacturing. Various embodiments include methods and systems for producing workpieces with an additive production method.

### BACKGROUND

CN 2015 72919 U describes a slide used for smoothing a powder bed for a powder-bed-based additive production method. This slide is pushed over the surface of the powder bed, wherein said slide can consist of individual segments supported on springs, which, in the event of an obstacle being present in the powder bed, are raised and thus avoid the method being aborted. Beyond the obstacle the slide segment concerned can be lowered back again into its original position, which is assisted by its sprung support.

Powder-bed-based additive production methods in the sense of this application are to be understood as methods in which the material from which the workpiece is to be produced are added to the workpiece while it is being made. In this case the workpiece already exists in its final shape or at least approximately in this shape. The building material is in powder form, wherein the material for producing the workpiece is physically hardened by the additive production method by the application of energy.

In order to be able to produce the component as a workpiece, data describing the component (CAD model) is prepared for the selected additive production method. For creation of instructions for the production system, the data is converted into data of the component adapted to the production method, so that the suitable process steps can run in the production system for successive production of the component. The data for this is prepared so that the geometrical data is available for the respective slices of the component to be produced, which is also referred to as slicing.

Selective Laser Sintering (SLS), Selective Laser Melting (SLM) and Electron Beam Melting (EBM) can be mentioned as examples of additive production. These methods are in particular suitable for processing of metallic materials in the form of powders, with which construction components can be produced. In SLM, SLS and EBM the components are produced slice by slice in a powder bed. These methods are therefore referred to as powder-bed-based additive production methods. A slice of the powder is created in each case in the powder bed, which is subsequently melted or sintered locally by the energy source (laser or electron beam) in those areas in which the component is to be produced. In this way the component is successively created slice by slice and can be removed from the powder bed once produced.

A characteristic of SLS is that the powder particles are not completely melted in said method. In SLS attention is paid to the choice of sinter temperature, so that this lies below the melting temperature of the powder particles. By contrast the amount of energy applied in SLM and EBM is deliberately high enough for the powder particles to be melted completely.

In additive production in the powder bed, there must be slice-by-slice application of the powder to the powder bed. This is embodied after the application or during the application with the aid of a slide as a thin layer with an even surface. Subsequently the layer of powder is melted locally, by means of a laser beam for example, in the areas that are to form the later component. During melting and the subsequent hardening errors and deviations in shape can occur, which are shown in FIG. 1. The following are considered as errors: Spatters, raised areas, recessed areas and edges. All these errors are characterized by the surface of the hardened material not lying in the intended constructive surface of the component slice currently to be produced, but below said surface or above it. In particular with errors that lie above the constructionally intended level, problems can arise during application of the subsequent layer of powder. If these areas also project from the subsequent layer of powder to be created, they collide with the slide that is used for smoothing the powder slice.

Additive manufacturing may include smoothing with a slide, even in the event of the presence of obstacles in the surface of the powder bed, in accordance with the aforementioned CN 2015 72919 U, by constructing said slide in segments. In the area of the obstacles the segments concerned will then be lifted by the obstacle and subsequently drop back into their original position. In this way the slide as a whole, at the level that is constructively intended, can be moved out of the way above the obstacle. In the area of the obstacle however the slide will not be totally effective, so that powder material remains in said area, which would have had to be smoothed by the slide per se. The effect of this is that ever more material is heaped up in the area of the error locations, whereby the error location continues to increase in size, which in the worst case leads to the method being aborted and to the component being produced being scrapped.

In said method a powder bed is created slice by slice, wherein the slice being created in each case is smoothed by a slide, which is moved with one edge to a target level of the slice being created. The edge of the slide, in the event of an obstacle projecting from the target level in the powder bed, is raised to a deflection level above the obstacle and is lowered down to the target level again once it has passed the obstacle. In this way the workpiece is built up slice by slice by local hardening of the powder, in that after the slice has been produced by means of the slide, a laser beam is used for example to melt the powder. Of course other additive production methods such as e.g. electron beam melting or selective laser sintering are able to be used as possible alternate methods.

### SUMMARY

An example method for producing a workpiece by means of an additive production method includes: a powder bed (12) is produced slice by slice (16), wherein the respective slice (21) being produced is smoothed with an edge (15) of a slide (13) down to a target level (14) of the slice (21) being produced, wherein the edge (15) of the slide (13), in the event of an obstacle (17, 18, 20) projecting from the target level (14) in the powder bed (12), is raised to a deflection level (22) above the obstacle (17, 18, 20) and, after it has passed the obstacle (17, 18, 20), is lowered back down to the target level, and a workpiece (11) is built up slice by slice (16) by local hardening of the powder, characterized in that after the slide (13) has passed the obstacle, the powder bed (12) is smoothed in the area of the obstacle with a brush (23).

In some embodiments, in the event of an obstacle (17, 18, 20) in the powder bed projecting from the target level (14), the brush (23) is guided horizontally over this obstacle.

In some embodiments, the brush (23) is guided at a height such that the ends of the bristles (26) of the brush (23) lie at a post-processing level (27), which is located above the target level (14).

In some embodiments, the difference in height h between target level (14) and post-processing level (27) amounts to at least 1% and at most 50%, or 10% of the layer thickness of the slice.

In some embodiments, the brush (23) is guided behind the slide (13) in the same direction.

In some embodiments, the obstacles (17, 18, 20) are detected by sensors.

In some embodiments, the slide (13) is raised to the deflection level (22) with an actuator (43).

As another example, some embodiments include a system for producing a workpiece by means of an additive production method, having: a receptacle (32) for a powder bed (12); a slide (13), which is able to be shifted with an edge (15) on a target level (14) of slices (21) of the powder bed to be produced; a deflection mechanism, which, if obstacles (17, 18, 20) are present, allows a deflection of the edge (15) to a deflection level (22) lying above the obstacle (17, 18, 20); and a brush (23) is provided in addition to the slide (13), which is able to be shifted horizontally with the ends of its bristles (26) to a target level (14) of slices (21) of the powder bed to be produced or to a post-processing level (27), which is located above the target level (14).

In some embodiments, the brush (23) and the slide (13) are able to be shifted in the same direction of advance (24) and the brush is arranged to follow the slide (13) in direction of advance (24). In some embodiments, a brush (23) is arranged on both sides of the slide (13) in each case.

In some embodiments, the order of brush (23) and slide (13) can be swapped with a switchover mechanism.

### BRIEF DESCRIPTION OF THE DRAWINGS

Further details of the teachings herein are described below on the basis of the drawings. Elements of the drawing that are the same or that correspond to one another are labeled with the same reference characters in each case and are only explained more than once in as far as differences between the individual figures emerge. In the figures:

FIG. 1 shows the schematic diagram of various error locations in the surface of a powder bed;

FIGS. 2 to 4 show different stages of an exemplary method incorporating teachings of the present disclosure in a view from the side;

FIG. 5 shows an exemplary system incorporating teachings of the present disclosure in a cross section; and

FIGS. 6 and 7 show exemplary brush-slide combinations, as can be used in a system in accordance with FIG. 5.

### DETAILED DESCRIPTION

Some embodiments on of the teachings herein include a system for creating a workpiece by an additive production method, having a receptacle for a powder bed. A slide is provided for this powder bed, which is able to be shifted with one edge at a target level of the slices to be created in the powder bed. Moreover a deflection mechanism is provided, which, in the event of obstacles being present, allows the edge to be deflected to a deflection level lying above the obstacle. Some embodiments include a method of the type specified at the outset or a system specified at the outset modified in such a way that it is possible to smooth a powder bed for the additive production of a workpiece effectively and reliably even when obstacles are present.

In some embodiments, the powder bed, after the slide has passed the obstacle, being smoothed with a brush in the area of the obstacle. The use of a brush has the advantage that said brush does not have to be raised in its entirety in order to pass over the obstacle. Instead the bristles are elastic enough to deviate in the area of the obstacle by elastic deformation. Here however they directly follow the shape of the obstacle, so that the powder that surrounds the obstacle can be smoothed effectively. Thus almost no powder residues which project above the constructionally intended level of the current powder slice remain around the obstacle. The brush can always be guided behind the slide, so that a smoothing of the powder bed areas that lie higher than the target level (for example because of an obstacle) takes place automatically. Since the slide is used before the brush, said slide takes on the main part of the task of smoothing the powder bed. In some embodiments, the slide can create an especially smooth surface of the powder bed. In some embodiments, with the aid of a slide it may be easier to remove larger amounts of surplus powder from the surface of the powder bed, in that this surplus amount of powder can be pushed in front of the slide. The brush merely has to remove small powder residues in the area of the obstacles, whereby the bristles may be prevented from becoming full of surplus powder.

In some embodiments, only in the event of an obstacle projecting from the target level in the powder bed are the bristles conveyed horizontally over this obstacle. For this purpose, the brush can be lowered onto the powder bed only in the area of the obstacles and otherwise remain at a distance from the powder bed. In some embodiments, areas of the powder bed already smoothed by the slide are not smoothed once again, since a deterioration of the powder bed surface could arise in this way.

In some embodiments, the brush may be conveyed at such a height that the bristle ends of the brush lie at a post-processing level that is located above the target level. The post-processing level should thus be at a certain distance from the surface of the powder bed that is chosen to be as small as possible, so that the ends of the bristles do not touch the powder bed outside obstacles. Where obstacles project from the powder bed it is still possible for the ends of the bristles to brush along the surface of the obstacle and to remove powder residues from it, so that the overall result is an improvement in the quality of the surface of the powder bed.

In some embodiments, there is a difference in height h between target level and post-processing level amounting to at least 1% and at most 50%, or even 10% of the layer thickness of the slice.

On the one hand this guarantees a sufficient safety margin, so that the bristles, in areas where the quality of the surface of the powder bed is already sufficient, can be conveyed across the powder bed without touching it. On the other hand, the difference in height is sufficiently small for surplus powder material to be removed almost completely in areas of obstacles and for an improvement in the surface of the powder bed to be achieved.

In some embodiments, the brush may follow on after the slide in the same direction. In some embodiments, a reduced control effort arises here, since the brush automatically captures the powder residues that lie above the level of the surface of the powder bed. The brush can track the slide at a constant distance from it for example, wherein brush and slide can be coupled mechanically to one another and be moved by the same actuator. In some embodiments, the brush and slide are manipulated with separate actuators, wherein brush and slide can be operated at different levels and in different directions. For example, it is also possible for a narrower brush to be moved at a right angle to the slide and be moved directly to existing obstacles.

In some embodiments, the obstacles are detected by sensor. This is possible for example by using an Automatic Optical Inspection system (AOI). Error locations in the powder bed surface can be recognized and localized by means of an image sensor, so that it is made possible for the brush to move to said locations directly.

In some embodiments, the slide can be designed to be elastic, so that the edge of the slide is deflected automatically. In some embodiments, the slide may be raised with an actuator to the deflection level. This can optionally be done with the slide as a whole or with segments of the slide. The actuator can be embodied specially for raising segments of the slide locally. However, the actuator that changes the level of the slide as a whole slice by slice can also be used, wherein in this case a balancing of the level by means of the brush over the entire width of the slide is necessary.

In some embodiments, there is a brush in addition to the slide, which is able to be moved with the ends of its bristles to a target level of slices of the powder bed to be created. In other words, a movement mechanism makes it possible to move the brush correspondingly to the slide in the powder bed surface. In some embodiments, the ends of the bristles may be moved horizontally at a post-processing level that is located above the target level. This enables the distance between the ends of the bristles and the areas of the powder bed that have already been smoothed by the slide with a sufficient quality to be maintained. The advantages of the system described have already been explained within the framework of the associated method and are produced as soon as the method is carried out on the system.

In some embodiments, the brush and the slide may be moved in a common direction of advance and for the brush to be arranged following on from the slide in the direction of advance. This produces a layout of the system with which an easily controllable method can be carried out. In the event of there being obstacles in the powder bed, the brush automatically smoothes the powder bed as well as possible in the areas of the obstacles. However, the direction of advance may be predetermined by the fact that the brush must always follow the slide.

If it is desired that the slide can be pushed in opposite directions over the powder bed, a brush may be arranged on both sides of the slide. The brush that is arranged following the slide in the current direction of movement is then used in each case. In some embodiments, the respective brush not being used may be cleaned during this time.

In some embodiments, the order of brush and slide may be swapped with a switchover mechanism. Here too it is possible for a combination of brush and slide to be able to be used in opposite directions, so that the powder bed can be smoothed in two opposite directions. This avoids movement times of the slide that would slow down the method.

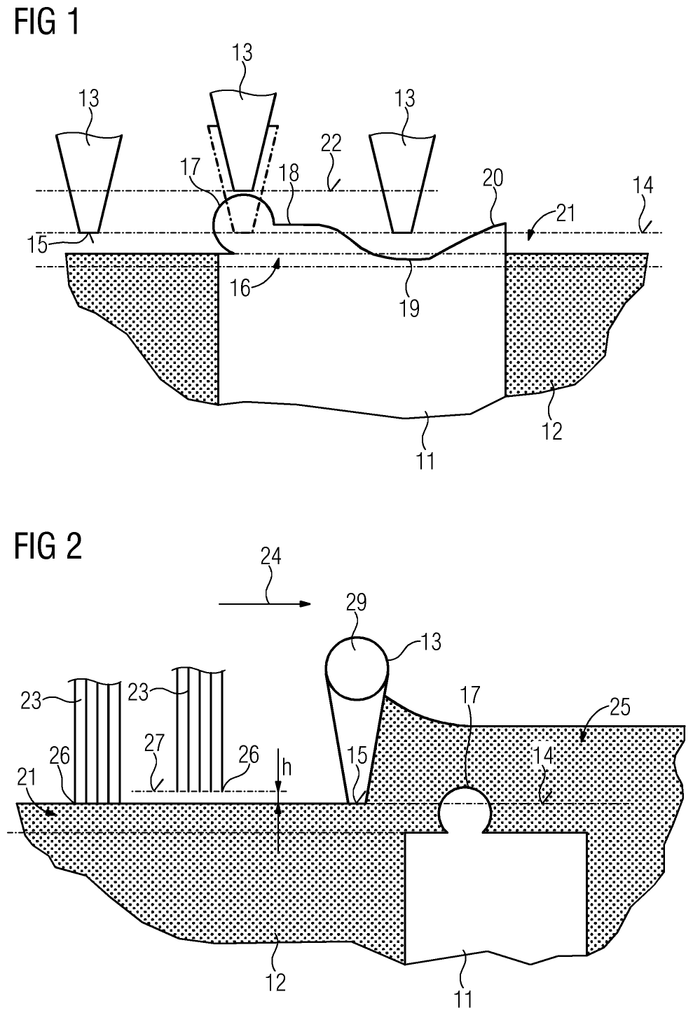

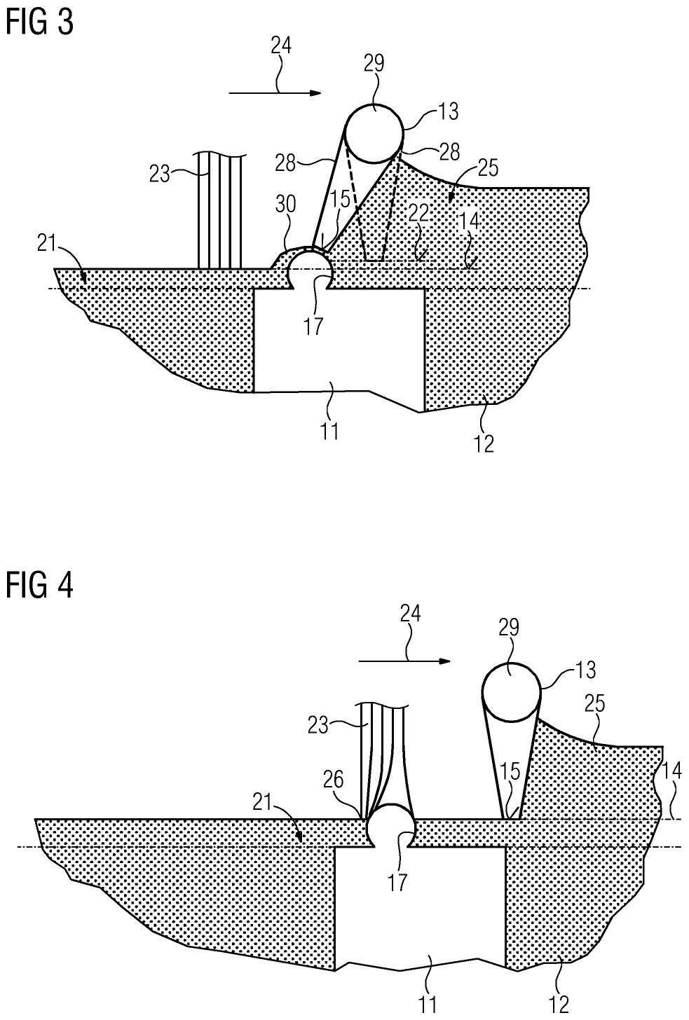

Shown in FIG. 1 is a workpiece 11, which will be produced in a powder bed 12. Also shown is a slide 13, which can be guided into different positions above the powder bed in order to smooth the surface to be produced to a target level 14. To this end the slide 13 will be conveyed with an edge 15 over the powder bed and, when this is done, a quantity of powder not shown is distributed onto the powder bed and smoothed (cf. also FIGS. 2 to 4). The workpiece 11 is produced slice by slice 16 on the powder bed 12.

In FIG. 1 only the last slice 16 produced is indicated by a dotted and dashed line. This is located both in the workpiece 11, where the slice 16 has been hardened, for example by means of a laser beam, and also in the powder bed 12. This slice 16 forms the current surface of the powder bed 12 at that moment and is also intended to form the surface of the workpiece 11.

However, the workpiece 11 is shown with various error locations, which lie outside the surface of the workpiece intended for its construction, as will be explained in greater detail below. The error locations can consist of a spatter 17, a raised area 18, a recessed area 19, and/or a workpiece edge 20. A spatter can arise for example when melted or melted-on particles of the powder bed are stirred up during the method and subsequently land on the surface of the powder bed or the workpiece and remain adhered to it. Raised areas, recessed areas, and edges can occur when a slice 21 being created is not embodied in an even thickness and too much or too little material is available for melting. These error locations reduce the quality of the workpiece and are thus to be avoided where possible.

In addition, these error locations are problematic for a distribution of subsequent powder layers, when said locations project above the target level 14 of the slice 21 to be created. In this case the result can namely be a collision of the edge 15 of the slide 13 with the obstacle 17, 18, 19 concerned.

As can be seen from the example of the spatter 17, the edge 15 of the slide 13 can then deflect to a deflection level 22 in order to be able to be guided over the corresponding obstacle without colliding with it. Powder residues then remain on the spatter 17 or on another comparable obstacle, which is not shown in FIG. 1, in this area. These powder residues reduce the quality of the workpiece during subsequent production steps and lead to a further enlargement of the error location, so that the negative effects become ever greater. This can even lead to the production method being aborted and to workpieces to be produced being scrapped.

To counteract this, there can be a smoothing of the powder bed 12 according to the invention as depicted in FIG. 2 with the slide and with a brush 23 following behind it, wherein the brush 23 is shown in different possible positions in FIG. 2 (only one of the two brushes 23 is necessary in order to be able to carry out the method). The workpiece is shown in accordance with FIG. 2 by way of example with a spatter 17 as the obstacle (other obstacles in accordance with FIG. 1 are likewise conceivable).

As can be seen from FIG. 2, the slide 13 is conveyed in a direction of advance 24 with its edge 15 above the powder bed, wherein the surface of the current slice 21 to be produced is smoothed to a target level 14. In this case the slide 13 pushes a surplus quantity of powder 25 in front of it. The brush 23 in this case is guided behind the slide at a certain distance, wherein the ends of the bristles 26 of the brush 23 can be located precisely at the target level 14 or at a post-processing level 27. The post-processing level 27 has a height difference h from the target level 14, so that the ends of the bristles 26 do not touch the surface of the powder bed 12 and thus cannot influence the surface quality of the powder bed.

It can be seen from FIG. 3 that the slide 13 consists of individual segments 28, which are arranged pivotably independently of one another about an axis of rotation 29, wherein the axis of rotation 29 lies at right angles to the plane of the drawing. It can be seen that one of the segments 28 is being lifted by the spatter 17 to a deflection level 22, in that the segment 28 concerned is being pivoted. The segment 28, which is located in the direction of view of the observer behind the deflecting segment 28, is shown by a dashed line. The pivoting of the one segment 28 enables powder to get behind the slide between adjacent segments, seen in the direction of advance 24. The deflecting segment 28 can also not completely remove the powder in front of the spatter 17, which is indicated by a powder residue 30. After passing the spatter 17, the segment 28 concerned pivots back into its target position, which can be brought about for example by a return spring not shown in the figure.

It can be seen in FIG. 4 that the slide 13 has now completely passed the spatter 17. The brush 23 has now arrived at the spatter 7, wherein it can be seen that the ends of the bristles 26 are following the shape of the surface of the spatter 17, while the bristles themselves deform elastically. This enables the powder residue 30 (see FIG. 3) to be removed, wherein a part of the powder residue will be caught between the bristles and a further part distributed evenly over the surface of the powder bed, so that the target level 14 of the powder bed will largely be maintained, even in the environment of the spatter 17.

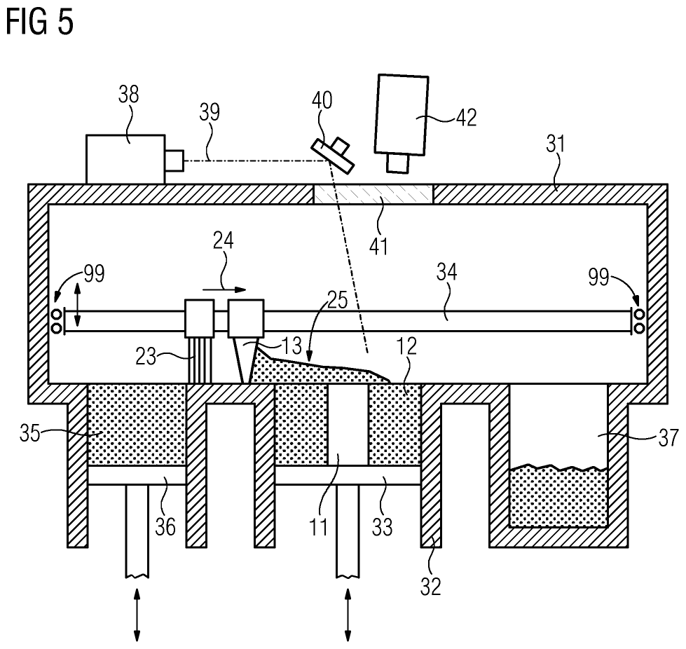

Shown in FIG. 5 is a system for selective laser melting. This has a process chamber 31, in which a receptacle for the powder bed 12 is provided. In this receptacle 32 a construction platform 33 for the workpiece 11 can be moved axially. By lowering the construction platform slice by slice, slices of the powder bed no longer shown can be created by means of the slide 13 and the brush 23 in the way described. For this purpose the slide 13 and the brush 23 are able to be moved horizontally on a retaining facility 34. The retaining facility 34 itself is also able to be moved vertically via a support 99 in the process chamber.

First of all the slide 13 moves over a powder reservoir 35, where the quantity of powder 25 is made available by a dosing piston 36. The slide 13 pushes this over the powder bed while producing the current slice to be melted, not shown in any greater detail. The slide 13 pushes surplus powder of the quantity of powder 25 into a collection container 37.

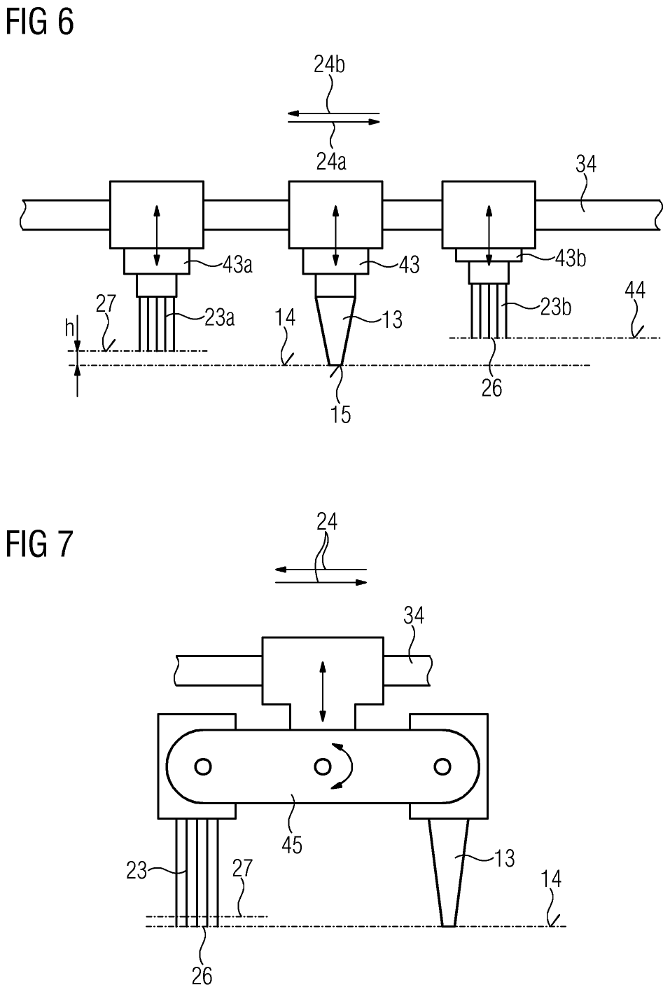

Subsequently a laser 38 is activated. A beam path 39 of the laser is shown, which leads via a diversion mirror 40 through a process window 41 to the surface of the powder bed 12. The surface of the powder bed 12 can also be monitored through the process window by means of a camera 42. The result of the monitoring can be used, in a way not shown in any greater detail, to activate an actuator 43 (cf. FIG. 6), in order to actively lift the slide 13 over an obstacle.

Shown in FIG. 6 is an arrangement, in which the slide 13 able to be displaced horizontally by means of the actuator 43 in the direction of the double-ended arrow is supported on the retaining device 34. In this way the slide 13 can be lifted actively to a deflection level 22 (cf. FIG. 1). Supported on the retaining device 34 in front of and behind the slide 13 respectively is a brush 23a, 23b. The brushes 23a, 23b able to be displaced vertically with the actuators 43a, 43b are also supported (double-end arrow shown).

Shown in FIG. 6 is a positioning of the brushes 23a, 23b for the direction of advance 24a. The brush 23a is set to the post-processing level 27 here, so that if obstacles are present, powder residues will be removed automatically by the ends of the bristles of brush 23a. The brush 23b is raised to a passive level 44, where the ends of the bristles are sufficiently far from the surface of the powder bed in the target level 14, so that they do not touch it (even if obstacles are present).

If the direction of advance 24b is selected, then the brush 43b is to be set to the post-processing level 27, while the brush 23a must be raised to the passive level. Subsequently the slide 13 can be moved in the direction of advance 24b, wherein a post-processing of the surface of the powder bed by the brush 23b is guaranteed.

It is shown in FIG. 7 that two opposite directions of advance 24 can also be realized in each case with only one brush 23 and one slide 13. The slide 13 and the brush 23 are supported on a pivotably-supported switchover mechanism 45. The slide 13 and the brush 26 are aligned relative to the target level 14 when the switchover mechanism 45 is horizontal. By turning the switchover mechanism 45 slightly however, a setting of the ends of the bristles 26 above the target level to the post-processing level 27 is also possible (not shown).

What is claimed is:

1. A method for producing a workpiece by means of an additive production method, the method comprising:
producing a powder bed slice by slice;
smoothing a respective slice being produced with an edge of a slide down to a target level of the respective slice;
raising the edge of the slide if an obstacle projects from the target level in the powder bed to a deflection level above the obstacle and, after it has passed the obstacle, lowering the edge of the slide back down to the target level;
after the slide has passed the obstacle, smoothing the powder bed in an area of the obstacle using a brush; and
building a workpiece slice by slice using local hardening of the powder.

2. The method as claimed in claim 1, further comprising, in the event of an obstacle in the powder bed projecting from the target level, guiding the brush horizontally over this obstacle.

3. The method as claimed in claim 1, further comprising guiding the brush at a height such that the ends of bristles of the brush lie at a post-processing level located above the target level.

4. The method as claimed in claim 3, wherein a difference in height between the target level and the post-processing level amounts to at least 1% and at most 50% of the layer thickness of the respective slice.

5. The method as claimed in claim 1, wherein the brush is guided behind the slide in the same direction.

6. The method as claimed in claim 1, further comprising detecting the obstacles with sensors.

7. The method as claimed in claim 6, wherein the slide is raised to the deflection level with an actuator.

8. A system for producing a workpiece by means of an additive production method, the system comprising:
a receptacle for a powder bed;
a slide movable to locate an edge on a target level of respective slices of the powder bed;
a deflection mechanism, which, if obstacles are present, allows a deflection of the edge to a deflection level above the obstacle; and
a brush horizontally movable to locate ends of associated bristles to a desired level of respective slices of the powder bed to be produced or to a post-processing level located above the target level.

9. The system as claimed in claim 8, wherein the brush and the slide are movable in the same direction of advance and the brush is arranged to follow the slide in direction of advance.

10. The system as claimed in claim 9, further comprising a second brush;
wherein one of the two brushes is arranged on each side of the slide.

11. The system as claimed in claim 9, further comprising a switchover mechanism to swap an order of the brush and the slide.
